(19) United States
(12) Patent Application Publication
(10) Pub. No.: US 2006/0191756 A1
(43) Pub. Date: Aug. 31, 2006

(54) Toroidal rotary damping apparatus

(76) Inventor: Norick B. Moradian, Berkeley, CA (US)

Correspondence Address: STAINBROOK & STAINBROOK, LLP, 3558 ROUND BARN BLVD., SUITE 203, SANTA ROSA, CA, 95403, US

(21) Appl. No.: 11/375,803

(22) Filed: Mar. 14, 2006

Related U.S. Application Data
(63) Continuation-in-part of application No. 10/294,019, filed on Nov. 12, 2002, now Pat. No. 7,048,098.

(51) Int. Cl. F16D 57/02

(52) U.S. Cl. 188/296; 188/294

(57) ABSTRACT

A toroidal rotary damper apparatus includes a housing having a partial toroidal inner housing surface and a piston moveable in the housing having a curved outer peripheral piston surface in engagement with the inner housing surface. The housing includes terminal ends defining fluid barriers. A flow control passageway defined by either the piston or an external control system controls passage of damper fluid when there is relative rotational movement between the piston and the housing to dampen the forces causing relative rotational movement.

### CROSS REFERENCES TO RELATED APPLICATIONS

The present application claims the benefit of U.S. Utility Patent Application Ser. No. 10/294,019, filed 11/12/2002 (Nov. 12, 2002).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention:

The present invention relates to a rotary damper apparatus which has a number of advantages over prior art damper constructions. The rotary damper apparatus is assembled within a toroidal housing and has superior sealing properties due to the constant engagement between a disc-like circular piston and the interior of a housing shaped in a full or partial toroid (or torus or anchor ring).

2. Discussion of Related Art including information disclosed under 37 CFR §§1.97, 1.98:

Dampers are hydraulic devices used to restrict the number of cyclic oscillations caused by a deflection force; damping forces are generated by pumping fluid through regulating orifices, converting kinetic energy into laminar and turbulent friction. Two types of damping devices are currently in wide use; telescopic and rotary vane type.

Traditional vane-type rotary dampers have inherent disadvantages, including the following:

Hysteresis: Due to disproportionate vane seal pre-load; caused by means such as compression springs, long elastomer seals, band springs and composite seal springs, resulting in substantial frictional losses, non-uniform sealing and curtailed dynamic range.

Excessive Leakage: As rotary vane damper housing is subject to hoop stress and side-load deformation, additionally, the vane is subject to bending strain at tip extremities, resulting in excessive bypass leakage flow and ensuing loss of fluid pressure.

Thermal hysteresis: This is due to non-uniform coefficient of expansion of damper housing and vane contact surfaces; exasperated by long linear sealing contours of the vane with mating surfaces, leading to unstable damping characteristics, also known as “fade” over the operating temperature ranges. This limits the effective operating temperature span and diminishes damping efficiency during thermal cycle. Furthermore, such prior art devices are hampered by their relative complexity, size, weight and high cost.

The following U.S. patents disclose rotary dampers believed to be representative of the current state of the prior art: U.S. Pat. No. 4,926,984, issued May 22, 1990, U.S. Pat. No. 5,577,761, issued Nov. 26, 1996, U.S. Pat. No. 5,324,065, issued Jun. 28, 1994, U.S. Pat. No. 4,886,149, issued Dec. 12, 1989, U.S. Pat. No. 5,400,878, issued Mar. 28, 1995, U.S. Pat. No. 5,381,877, issued Jan. 17, 1995, and U.S. Pat. No. 6,296,090, issued Oct. 2, 2001.

Telescopic piston dampers are well known constructions employing a pressurized chamber or cylinder having a piston movable therein under controlled conditions and a piston rod associated therewith to provide the transfer of dampening force. These traditional-type dampers have certain fundamental drawbacks as well. In such devices, due to the fact that the piston rod enters through one end of the damper, there is a dynamic internal volume and pressure differential due to rod volume inclusion within the damper fluid volume, necessitating measures to counter damper volume imbalance by either pressurizing the opposing chamber by means of highly compressed gas and a dividing piston, as in a monotube gas design, or a secondary chamber, via a foot valve, as in the known double-tube design, or by inclusion of a complimentary dummy shaft to equalize internal volume. All of the above measures reduce damping efficiency, add cost, complexity and weight as well as require additional space.

Since telescopic dampers, to conform to non-linear elasto-kinematics motion of the associate elements, are deployed predominantly with translational mechanisms, they cannot be installed directly, or fixedly to a haul or a chassis. This curtails the thermal conductance capacity of the damper and of the fluid. Under severe operating conditions, fluid temperature can rise to well over 100 degrees C., resulting in reduced fluid viscosity and vaporization of dissolved gases in the fluid, known as cavitation. At higher temperatures, damping forces diminish exponentially due to fluid viscosity reduction, giving higher orifice discharge coefficient. Also, conventional translational or linear dampers have limitations when applied to long travel functions. It is difficult to accommodate a large travel due to the danger of bucking the damper shaft, especially at high relative velocities; the linear space claim required by the length of a linear damper can also create packaging problems.

Functionally, in order to modify the desired damper force-velocity characteristics, it is highly problematic to adjust the telescopic piston-valve in situ; solutions such as a hollow piston rod containing an internal shaft that performs the adjustments are very costly and frequently incompatible with servo controls due to high torque demands. Piston embedded servo valves are also complex, as well as reducing the hydraulic capacity of the damper.

As described earlier, to adapt to non-linear and elasto-kinematic requirements of the damping structures, telescopic dampers are predominantly deployed via translational bushings, excluding the possibility of direct attachment of damper to the structures, hence impeding thermal transfer passage.

U.S. Pat. No. 5,971,118, issued to the present inventor on Oct. 26, 1999, discloses a motion dampening apparatus which includes a damper structure defining a curved damper housing interior for a fixed attachment to a first structural member and a curved damping element for a fixed attachment to a second structural member and movable within the curved damper housing interior along a curved path of movement.

While the prior art indicated above does not teach or suggest the combination of structural features disclosed and claimed herein, it demonstrates the viability of the novel concept of transition of a force-bearing piston within a radial or circular structure; it also teaches the importance of fixed attachment of a damper to its associated external structural members, resulting in a thermally conducting pathway between a damper and a structure, as well as eliminating the use of translational bushings from the damper mounting points, which are also a source of parasitic friction.

However, the foregoing patents reflect only the current state of the art of which the present inventor is aware. Reference to, and discussion of, these patents is intended to aid in discharging Applicant's acknowledged duty of candor in disclosing information that may be relevant to the examination of claims to the present invention. It is respectfully submitted that none of the above-indicated patents disclose, teach, suggest, show, or otherwise render obvious, either singly or when considered in combination, the invention described and claimed herein.

However, the foregoing patents reflect only the current state of the art of which the present inventor is aware. Reference to, and discussion of, these patents is intended to aid in discharging Applicant's acknowledged duty of candor in disclosing information that may be relevant to the examination of claims to the present invention. It is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention relates to a rotary damper apparatus which has a number of advantages over prior art damper constructions. The rotary damper apparatus is assembled within a toroidal housing and has superior sealing properties due to the constant engagement between a disc-like circular piston and the interior of a housing shaped in a full or partial toroid (or torus or anchor ring).

Due to symmetrical geometry of the piston and the surrounding arcuate interior, the piston seals do not require a pre-load force; this considerably reduces internal friction, leakage, and hysteresis. The apparatus has a low internal static pressure and a constant internal volume during operation, eliminating the need for a high-pressure gas accumulator or a secondary expansion chamber, as required by the telescopic design, to compensate for external rod volume fluctuations.

The damping torque T generated by the toroidal rotary damper, is determined by the volume of fluid displaced per angle of rotation θ, multiplied by pressure drop across the piston surface ΔP or: T=πθΔPR²r², where θ=angle in radian, ΔP=pressure drop across the piston, R =radius of the toroid, and r=radius of the damper piston.

The following relation converts rotary to linear motion: x=2πRθ/360. The damping rate is determined by the rate of change of ΔP, or rate at which the damping fluid is allowed to leak from the pressurized chamber across the piston orifices and valves, into the opposing chamber. Additionally, over a 90 degree sweep, mean toroidal volume displacement is 5% larger, hence generating 5% more damping force, than the equivalent linear displacement.

Furthermore, behavior of conventional telescopic damper is well understood, comprehensive mathematical models and fluid-dynamic simulations have been developed to analyze its characteristics, since the toroidal rotary damper employs piston, valving and cylindrical configuration substantially similar to that of telescopic dampers, all relevant analysis are directly applicable to the toroidal rotary damper system.

A toroidal rotary damper constructed in accordance with the present invention operates according to the following operating principle.

The apparatus has a wide dynamic damping range, approaching 340 degrees, as well as good thermal distribution due to a high rate of fluid circulation within the housing, and favorable thermal stability due to efficient heat dissipation throughout the apparatus exterior. The apparatus does not possess any inherent high stress points due to balanced load distribution across the circular piston surface, traversing within the interior of the torus.

The apparatus is relatively simple and inexpensive. Additionally, it provides the advantages of full adjustability during operation and ease of serviceability due to its modular construction.

The damper apparatus is extremely compact and adapted for installation in limited spaces. The apparatus can accept forces through a central shaft or at locations on the external housing and still effectively and efficiently provide damping forces. The inventive toroidal rotary damper can be installed either internally as an integral part of a suspension system or structure, or activated remotely via a lever arm and linkage. In addition the inventive toroidal rotary damper has a small space requirement, no exposed sealing surfaces, and therefore more resistance to debris and damage from foreign objects or harsh environments.

The inventive toroidal rotary damper can operate by means of wide selection of damping mediums, such as mineral based fluids, synthetic based fluids, magneto-rheological fluids, and compressed gases, such as air.

The inventive toroidal rotary damper apparatus includes a housing defining a housing interior for containing damper fluid. The housing interior is at least partially formed by a toroidal inner housing surface disposed about and spaced from an axis in a full or partial radial embodiment.

The inventive apparatus employs a disc-shaped piston. The curved outer peripheral piston surface shares a common plane with a central axis of the central shaft, from which it is spaced, and it remains in substantially fluid-tight engagement with the toroidal inner housing surface while rotating about the central axis. The housing and the piston are relatively rotatably moveable about the axis.

In a full radial embodiment, a fluid barrier is fixedly attached to the housing and positioned in the housing interior. In a partial radial embodiment, the two housing end-walls constitute two fluid barriers.

A flow control passageway (or control valve) is defined by either the piston or the fluid barrier for permitting controlled passage of damper fluid responsive to relative rotational movement between the piston and the housing. This dampens forces applied to the toroidal rotary damper apparatus, causing the relative rotational movement.

Since the thermal expansion coefficient of the damper fluid is higher than that of the damper housing components, in certain applications a low-pressure gas accumulator or a collapsible bladder may be provided in the interior of the housing to absorb excessive fluid pressure caused by thermal expansion of damper fluid. This prevents the formation of dissolved gases in the fluid and damage to seals, effectively functioning as a temperature compensation mechanism.

Blow-off valves may also be incorporated in the piston or the fluid barriers to limit the maximum transient pressure at impulse piston velocities, in order to avoid damage to the damper.

Other novel features characteristic of the invention, particularly as to organization and method of operation, together with the advantages thereof, will be better understood from the following description considered in connection with the accompanying drawings, in which several preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the national patent office(s) and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward”, “downward”, “left”, and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of a first preferred embodiment of toroidal rotary damper apparatus constructed in accordance with the teachings of the present invention;

FIG. 2 is a perspective view with the upper housing member of the apparatus removed and illustrating interior structure of the apparatus, including a piston and a fluid barrier;

FIG. 3 is an enlarged, cross-sectional view taken along section line 3-3 in FIG. 2;

FIG. 4 is an exploded, perspective view illustrating selected elements of the toroidal rotary damper apparatus;

FIG. 5 is an enlarged, detailed cross-sectional view in elevation, taken along section line 5-5 of FIG. 1;

FIG. 6 is a graphic representation showing force/velocity curves for various embodiments of the apparatus;

FIG. 7 is a view taken along the section 7-7 in FIG. 2, but illustrating an alternative embodiment which includes valves on the piston;

FIG. 8 is a view similar to FIG. 7, but illustrating yet another embodiment wherein valves are utilized on the fluid barrier of the apparatus;

FIG. 9 is a view similar to FIGS. 7 and 8, but illustrating still another embodiment of the invention, wherein two fluid barriers are employed and two pistons are employed in the apparatus, each piston having valves with chambers interconnected through fluid passageways in the radially protruding member and central shaft;

FIG. 10 illustrates another embodiment of the invention in which a single fluid barrier is provided and which is operatively associated with two spaced-apart pistons, each piston including valves;

FIG. 11 illustrates yet another embodiment utilizing valve controls for externally controlled operation of valves associated with a fluid barrier;

FIG. 12 illustrates another embodiment in which includes a preload structure for pressurizing damper fluid in the housing interior;

FIG. 13 is an upper perspective view illustrating an alternative housing configuration incorporating external connector portions for connecting the housing to structural elements;

FIG. 14 is a schematic top plan view illustrating the housing of FIG. 13 attached to two spaced structural elements;

FIG. 15 is a schematic top plan view showing an embodiment of the invention in which the housing has pivotally connected elongate rods such that the apparatus functions as a rocker damper;

FIG. 16 is a detailed cross-sectional side view in elevation illustrating a plurality of flow control passageways formed in the piston;

FIG. 17 illustrates the use of toroidal rotary damper apparatus of the present invention in association with a vehicle suspension system and operating in the capacity of a lever damper;

FIG. 18 illustrates the toroidal rotary damper apparatus deployed axially with the pivoted support shaft of a vehicle suspension system and affixed thereto;

FIG. 19 illustrates the toroidal rotary damper apparatus utilized in a vehicle suspension system to accept tangential force vectors using a push/pull rod and employed as a damped rocker system;

FIG. 20 is a schematic view showing the toroidal rotary damper apparatus incorporating a planetary gear assembly;

FIG. 21 shows the toroidal rotary damper apparatus incorporated into an external housing structure;

FIG. 22 is an upper perspective view showing a still further embodiment of the invention wherein a partial radial toroidal enclosure forms the damper housing;

FIG. 23 is a perspective view of the partial radial toroidal embodiment with the upper housing member of the apparatus removed and illustrating interior structure of the apparatus, including a piston and end-walls functioning as fluid barriers;

FIG. 24 is an enlarged, cross-sectional end view in elevation of the piston of the partial radial toroidal embodiment taken along section line 24-24 of FIG. 23;

FIG. 25 is an exploded perspective view of the apparatus of FIGS. 22-24 illustrating selected elements;

FIG. 26 is an enlarged, cross-sectional side view in elevation of the partial radial toroidal embodiment taken along section line 26A-26A of FIG. 26;

FIG. 26A is an enlarged partial detailed cross-section view of the partial radial toroidal damper apparatus taken along section line 26-26 of FIG. 22; and

FIG. 27 illustrates the partial toroidal embodiment of the inventive apparatus utilizing valve controls for externally controlled operation of valves associated with fluid barriers.

### DRAWING REFERENCE NUMERAL LEGEND

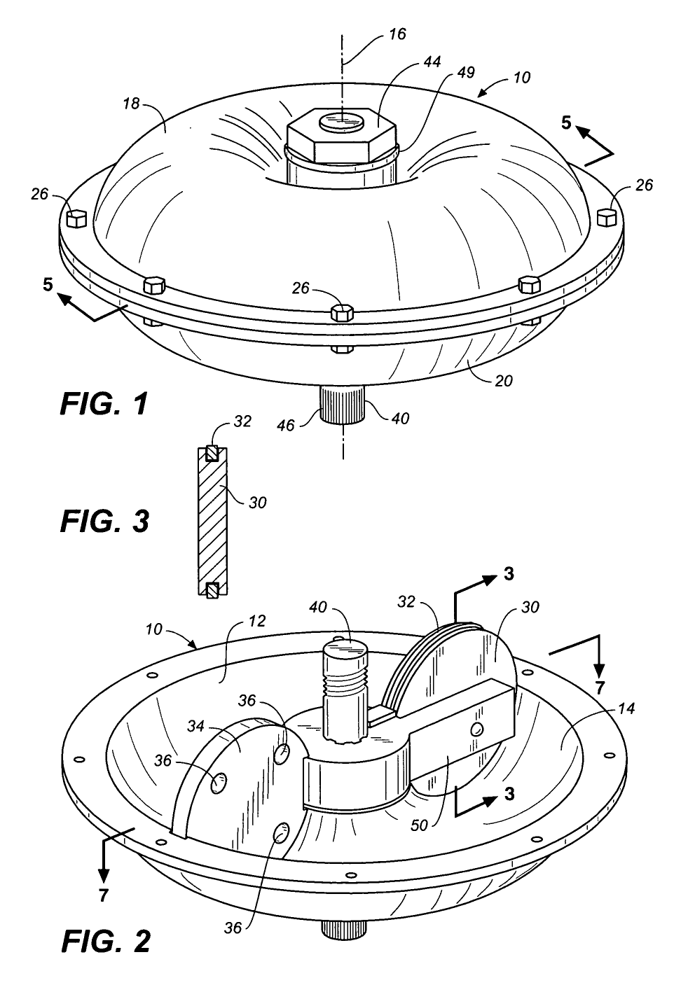

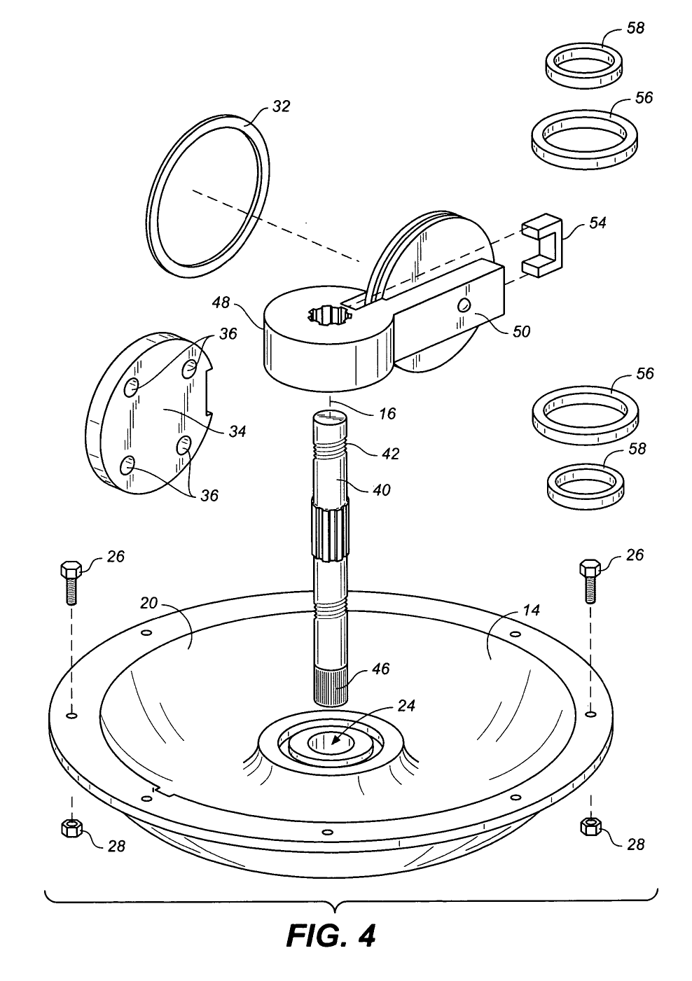

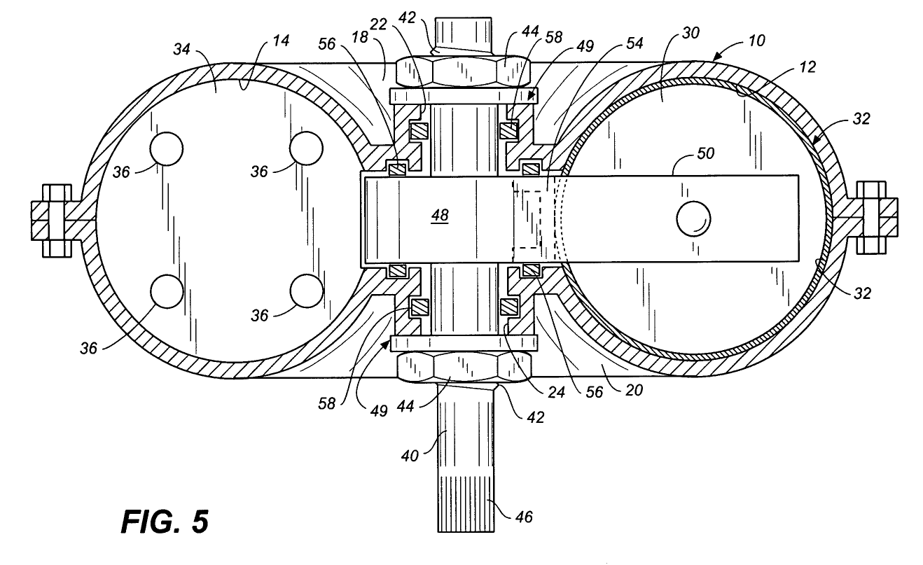

FIGS. 1-6
10 housing
12 housing interior
14 housing surface
16 central axis
18 upper housing member
20 lower housing member
22 opening at center of first housing member
24 opening at center of second housing member
26 threaded fasteners
28 nuts
30 piston
32 outer seal (ring)
34 fluid barrier
36 flow control orifices or passageways
40 shaft extending through housing interior along axis 16
42 threads
44 nuts
46 first end of shaft
48 radially protruding member (arm)
49 washers
50 elongated securement member
54 clip
56 radial face seals
58 axial seals

FIG. 7
10A housing interior
30A piston
34A fluid barrier
36A flow control valves
48B radially protruding member (arm)
60 valves

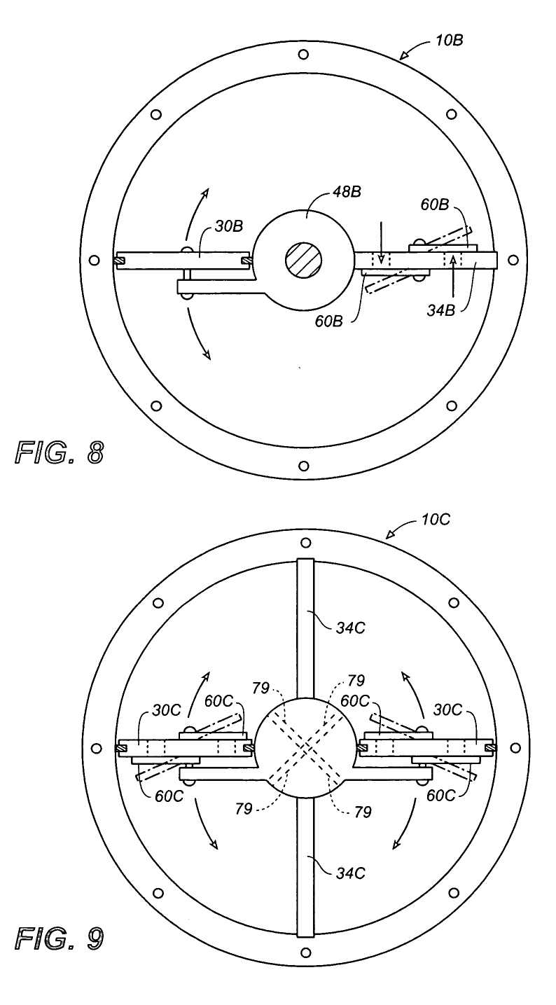

FIG. 8
30B piston
48B radially protruding member (arm)
60B valves

FIG. 9
10C housing
30C piston
34C fluid barriers
60C valves
79 fluid passageways in radially protruding member and central shaft

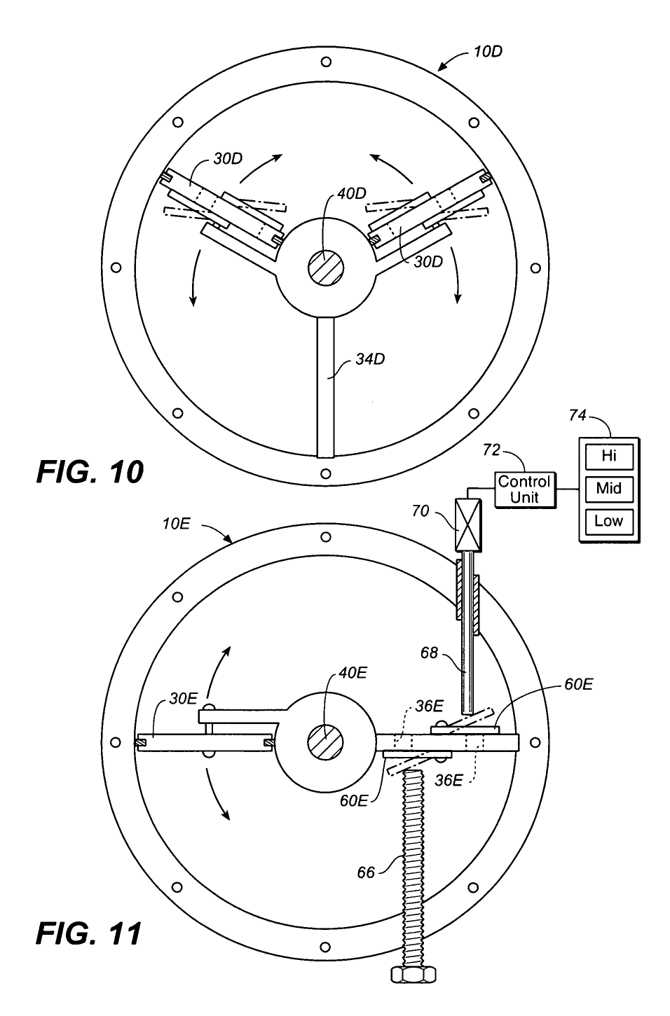

FIG. 10
30D pistons
34D fluid barrier
40D main rotating shaft

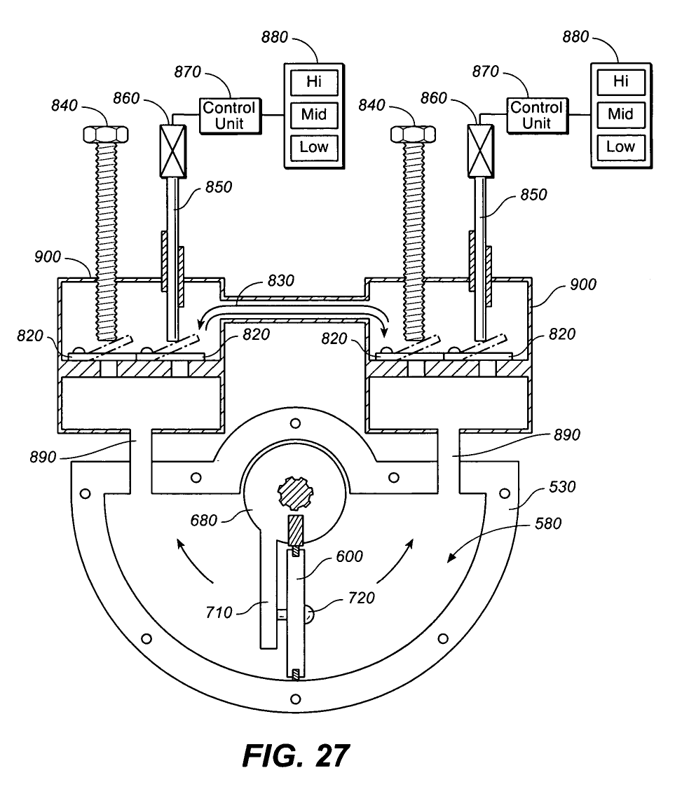

FIGS. 11, 27
36E flow control passageways
60E adjustable valves
66 symbolic manual adjustment screw
68 plunger
70 servo actuator
72 control unit or CPU
74 discrete control strategies

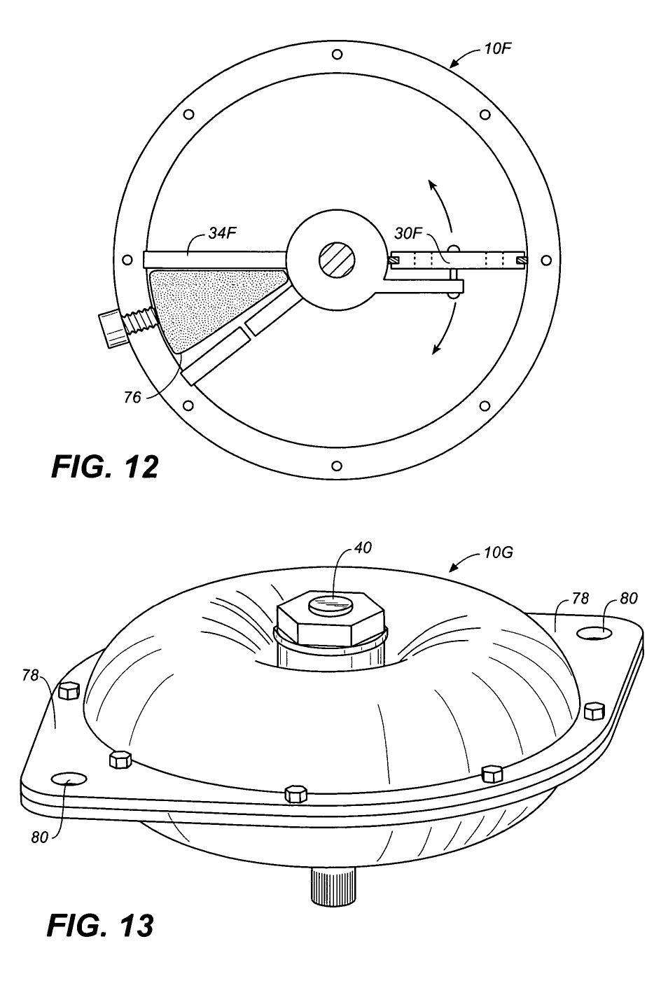

FIG. 12
10F housing
30F piston
34F fluid barrier
76 gas filled collapsible structure

FIG. 13
10G housing
78 enlarged flange segments
80 apertures

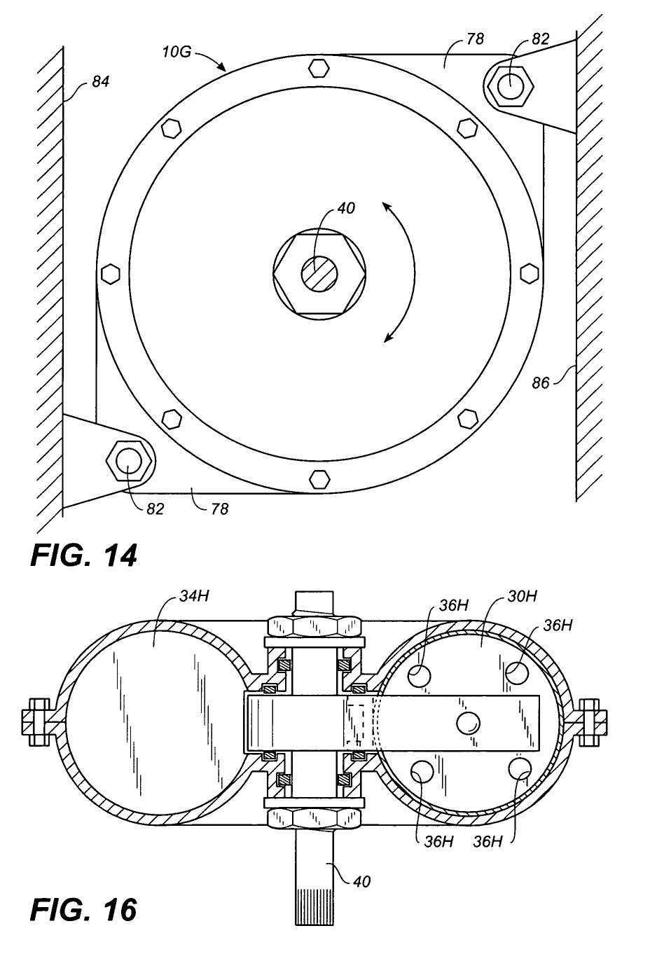

FIG. 14
10G housing
40 shaft
78 connector portions
82 bolts
84 fixed structural element
86 fixed structural element

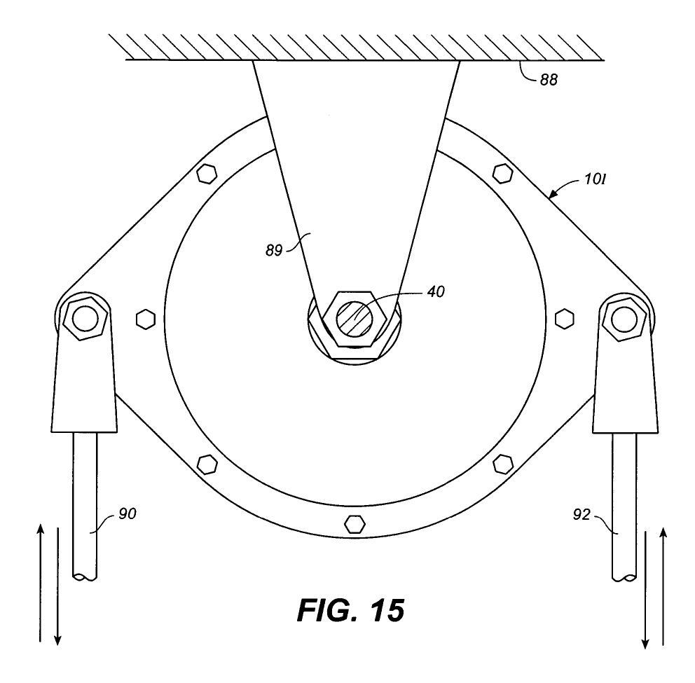

FIG. 15
10I housing
40 shaft
88 structural element
89 bracket
90 push-pull arm
92 push-pull arm

FIG. 16
30H piston
34H fluid barrier
36H flow control passageways

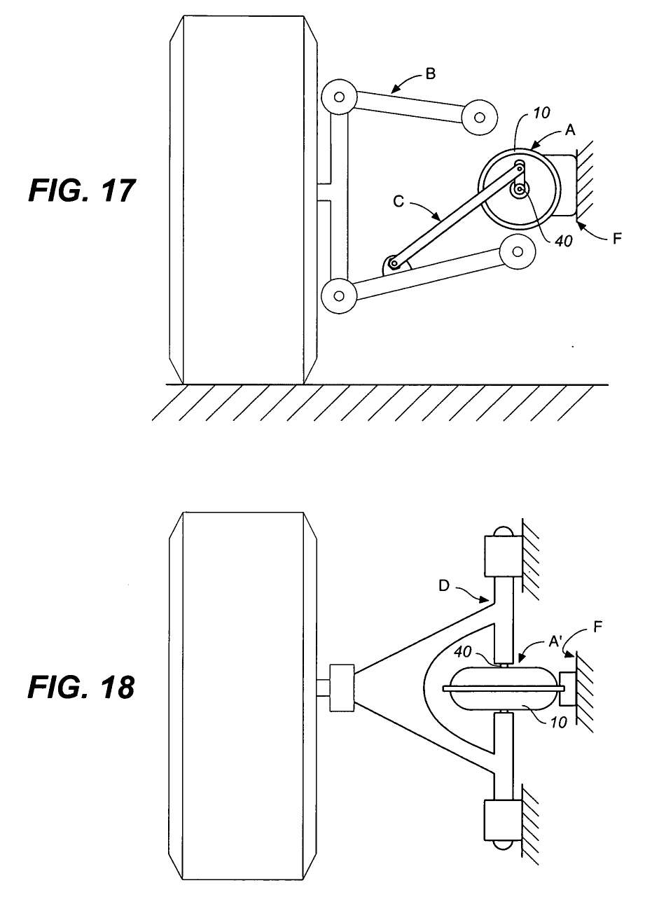

FIG. 17
10 housing
A toroidal rotary damper apparatus
B vehicle suspension system
C arm affixed to the central shaft 40
F vehicle frame
40 central shaft

FIG. 18
10 housing
A′ toroidal rotary damper apparatus
D elongate element
F vehicle frame

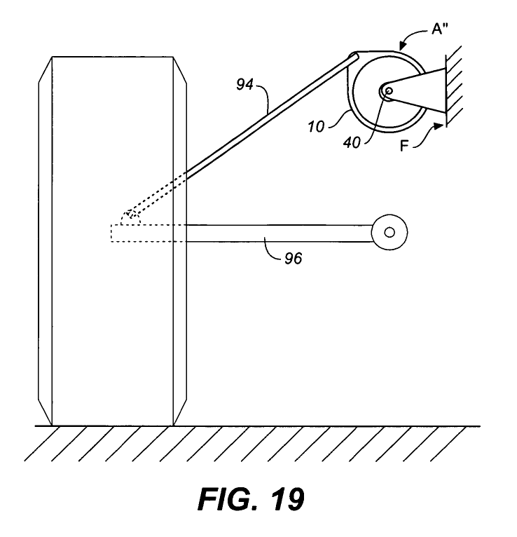

FIG. 19
10 housing
A″ toroidal damper apparatus
F vehicle frame
40 shaft
94 link rod
96 pivoted element

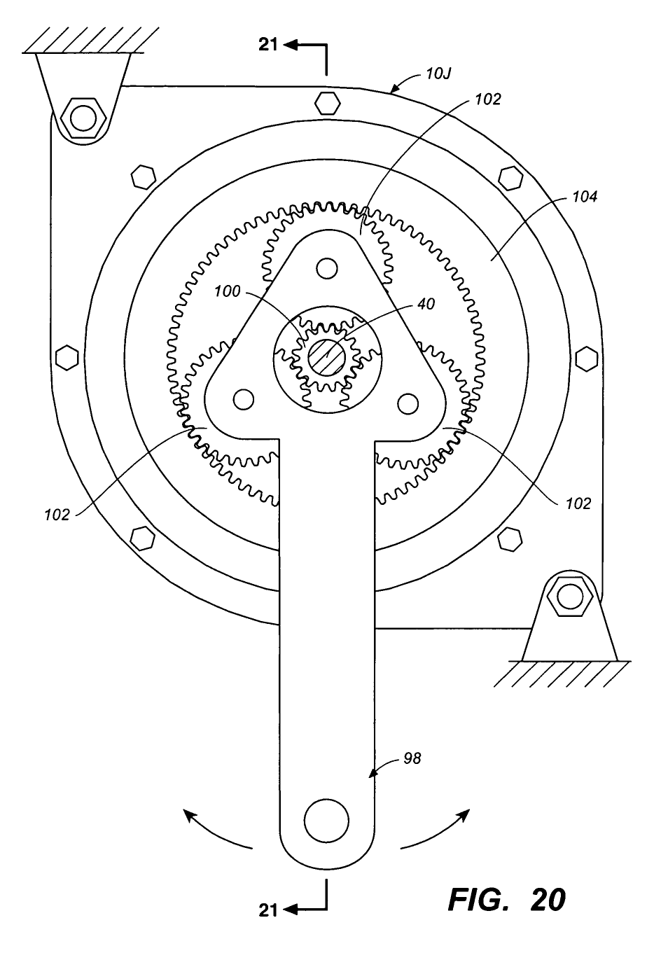

FIG. 20
10J housing
98 moveable output member/lever
100 sun gear
102 planetary gears
104 ring gear

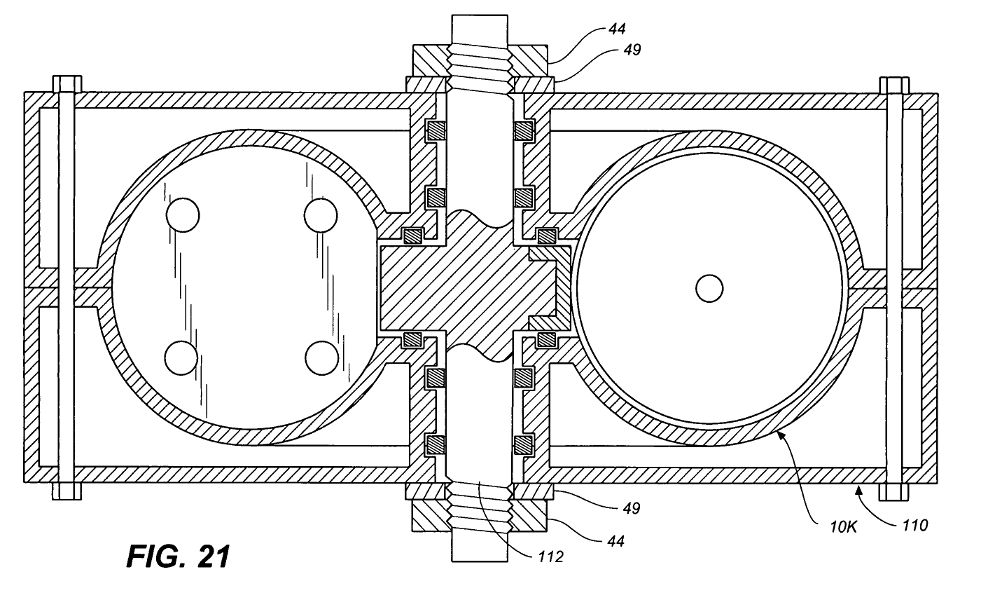

FIG. 21
10K toroidal rotary damper apparatus
44 nut
49 washer
110 external housing structure
112 shaft

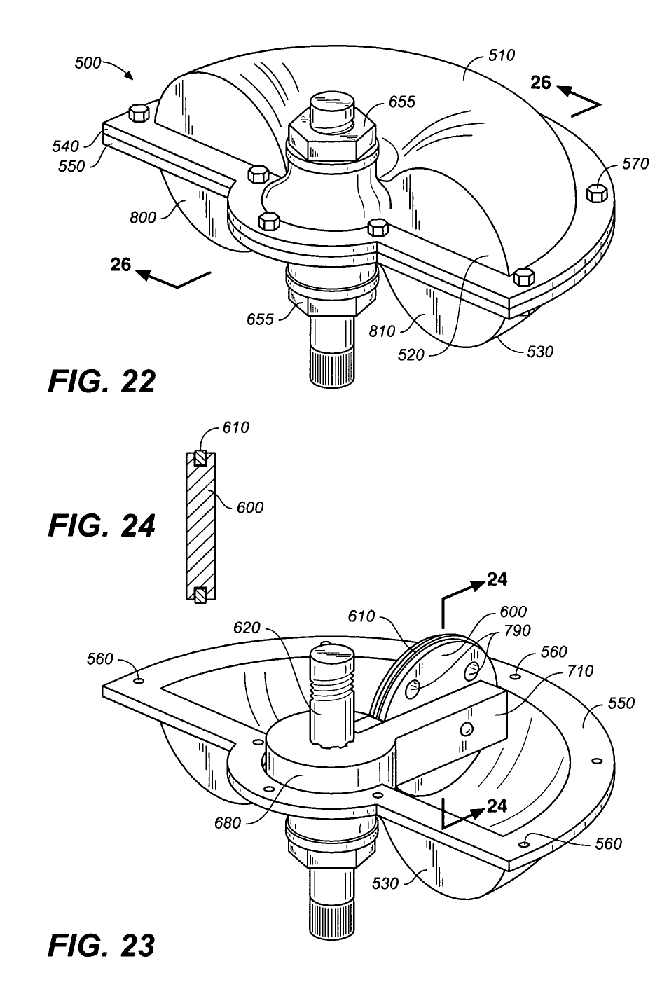

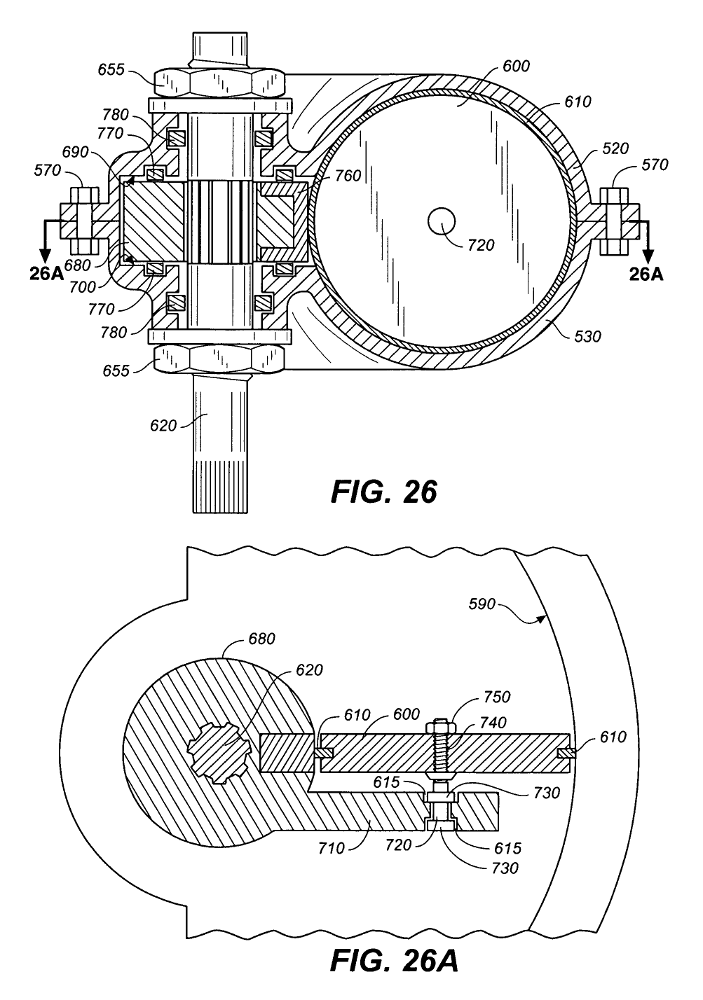

FIGS. 22-27
500 partial toroidal rotary damper apparatus
510 housing
520 upper toroid housing member
530 lower toroid housing member
540 flange
550 flange
560 apertures
570 fasteners
580 housing interior
590 interior surface
600 disc-shaped piston
610 piston ring
615 countersunk recesses
620 shaft
625 slot (for clip seal)
630 central axis
640 lower housing member hole
650 upper and lower threads on shaft
655 nuts
660 splines on shaft
670 splines in radial arm
690 upper housing member boss
700 lower housing member boss
710 bar
720 pin
730 countersunk elements
740 threaded portion of pin
750 nut
760 clip seal
770 radial face seals
780 axial seals
790 flow control orifices
800 terminal side of toroidal housing
810 terminal side of toroidal housing
820 adjustable valves
830 bi-directional fluid passageway
840 manual adjustment screw
850 plungers
860 servo actuators
870 control units
880 control strategies
890 fluid passageways
900 compression and extension fluid chambers

### DETAILED DESCRIPTION OF THE INVENTION

Referring now to FIGS. 1-6 and 22-26, wherein like reference numerals refer to like components in the various views, there is illustrated therein a new and improved toroidal rotary damper apparatus illustrated in accordance with the teachings of the present invention. The apparatus includes a housing 10 defining a housing interior 12 for containing damper fluid (not shown) of any conventional nature. The housing interior has a substantially circular cross section and is formed by a toroidal inner housing surface 14 disposed about and spaced from a central axis 16.

The housing 10 comprises two adjoining housing members 18, 20, each housing member defining a portion of the housing interior and further defining openings 22, 24, respectively, at the centers thereof. Threaded fasteners 26 extending through holes in outer flanges of the housing members are utilized to releasably secure the housing members together.

A disc-shaped piston 30 having a substantially circular outer peripheral piston surface at which is located an outer seal or ring 32 is in substantially fluid-tight, slidable engagement with the toroidal inner housing surface, spaced from axis 16 and disposed along a common plane with the axis 16. The housing 10 and the piston are relatively rotatably moveable about the axis, as will be described in greater detail below.

In a full radial housing embodiment, a fluid barrier 34 in the form of a plate is attached to the housing and positioned in the housing interior, in partial radial housing embodiment, the housing end-walls constitute the fluid barriers.

The fluid barrier 34 defines multiple flow control orifices or passageways 36 which permit restricted passage of damper fluid therethrough responsive to relative rotational movement between the piston 30 and the housing to dampen forces applied to the apparatus causing the relative rotational movement.

A shaft 40 extends through the housing interior along axis 16 and projects outwardly from opposed sides of the housing, the shaft passing through openings 22, 24 of the housing. A shaft end segment extends outwardly of each of the openings and is disposed outside the housing. Threads 42 are formed at two spaced locations on the shaft and the shaft is threadably engaged at those locations by nuts 44. In the arrangement illustrated, one end 46 of the shaft incorporates elongated, parallel projections to facilitate connection of the shaft to other structure, if desired. The shaft and nuts are rotatable as a unit relative to the housing. Washers 49 are disposed adjacent to nuts 44 and are slidable on shaft 40 to provide a sliding or bearing interface between housing members 18, 20 and the shaft.

Piston 30 is secured to shaft 40 by radially protruding member 48 affixed to shaft. In the embodiment illustrated, elongated securement member 50 extending from member 48 is disposed at sides of the piston 30 to secure the piston to member 48, it should be noted that piston 30 may be attached fixedly to one or multiple securement members, or held generally freely from opposing directions in what may be referred to as “floating” configuration, in between securement members 50.

Relative rotational movement between the housing and the piston about axis 16 will cause pressurized damper fluid in the housing interior to pass through flow control passageways 36 and thus dampen forces resulting in the relative rotational movement.

A number of seals are employed in the apparatus to prevent leakage of the pressurized damper fluid. At these locations, the compression seals surround the shaft and maintain pressurization of damper fluid within the housing interior. In addition, radial face seals 56 and axial seals 58 associated with each of the housing members and surrounding the shaft act as fluid stops between the shaft and housing to prevent possible fluid bypass. Seal 54 is installed in engagement with piston 30 at the location on member 48, at this location seal 54 prevents fluid leakage between member 48 and piston 30.

FIG. 7 illustrates an embodiment of the invention wherein the housing 10A interior accommodates a fluid barrier 34A which has no flow control valves formed therein. Instead, flow control valves 36A are located in piston 30A. In this arrangement, valves 60 which may, as illustrated, be in the form of shim valves, or other suitable hydraulic valves are attached to piston 30A and control the fluid flow passageways 36A depending upon the relative rotational direction of movement between the housing and piston.

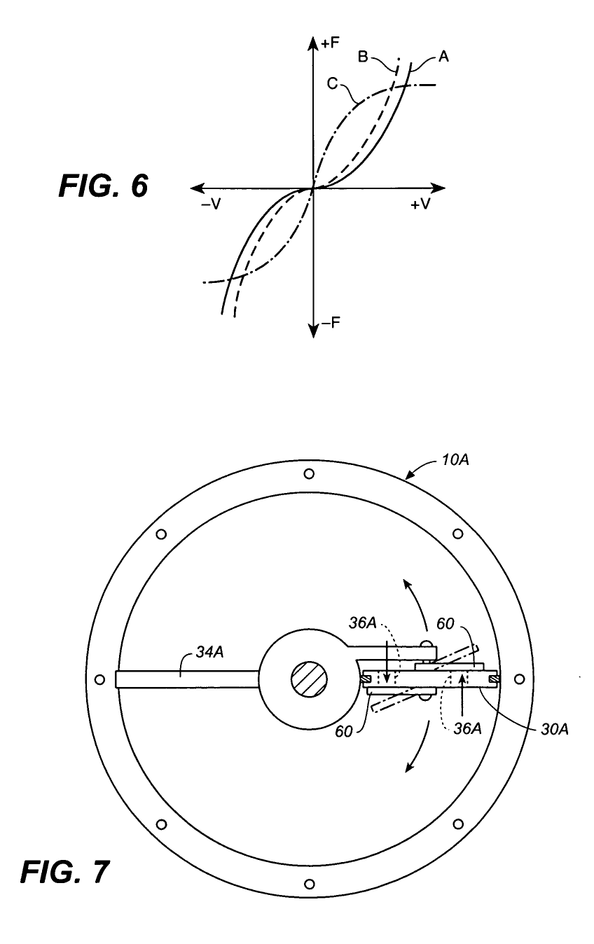

FIG. 6 illustrates a basic damper F(V) (Force versus Velocity) graph calculated from the valve (or flow control passageway) characteristics of the toroidal rotary damper apparatus on the basis of steady state analysis. For an open orifice damper, the damping force can be considered as proportional to piston speed, however, it is often desirable to include non-linear properties in the damping curve.

The toroidal rotary damper apparatus can use different flow control valve systems, such as the stacked-shims (spring plates) as shown or spring-loaded ball valves to modify the damping characteristics.

The graphs of FIG. 6 illustrates F(V) damping characteristics achieved by various valve applications: Graph A-B. Highly progressive damping curves achieved by various size open flow control passageways in the piston or fluid barriers; Graph C—Digressive damping curve achieved by stacked-shims in the piston or fluid barrier.

FIG. 8 illustrates an embodiment employing valves 60B to control damper fluid flow through flow control passageways formed in the fluid barrier. The housing interior accommodates a single piston 30B, disposed on radially protruding member, or arm 48B.

FIG. 9 illustrates an embodiment of the invention wherein housing 10C accommodates therein two fluid barriers 34C fixed in position within the housing interior and spaced from one another to divide the housing interior into two separate chambers. Each of the chambers accommodates a piston 30C therein. Valves 60C are associated with each of the pistons.

Employing the arrangement of FIG. 9, each damping chamber can be designed with different damping characteristics, e.g., one chamber can be solely dedicated to a compression cycle while the opposing chamber functioning in extension cycle, or to provide intermediate or transitional damping behavior. Additionally, more than two fluid barriers can be employed so that more than two chambers are formed. The chambers can also contain fluids with different properties (i.e. viscosity, density, thermal expansion, etc.) to achieve desired final damping characteristics. Advantages of this embodiment are better dynamic torque distribution within the damper and improved thermal energy dissipation. Additionally, the opposing chambers can be interconnected via fluid passageways 79 across the shaft, effectively doubling multiplying piston surface area, hence doubling the damping force.

In the arrangement of FIG. 10, a plurality of pistons 30D (in this case two pistons) are affixed to the main rotating shaft 40D within the single chamber defined by fluid barrier 34D. This divides the damping load between multiple pistons, with each piston possibly having a specific damping characteristic. Advantages are larger damping surface area and hence damping forces, improved dynamic torque distribution within the damper and enhanced thermal distribution within the fluid.

FIG. 11 is a schematic representations of an embodiment of the apparatus having adjustable valves 60E utilized to control flow through flow control passageways 36E. Valve adjustments are provided to modify operation of the damper, two different types of valve controls being shown. In one embodiment of valve control mechanism a symbolic manual adjustment screw 66 is associated with one of the valves 60E and may be threaded in or out relative to the housing to control how far its associated valve can be opened.

In the other valve control, a plunger 68 is associated with a different valve mechanism 60E to change the position of a needle valve. The plunger 68 extends from a servo actuator, which may, for example, be electrically or hydraulically operated. The servo actuator 70 is operatively associated with a control unit or CPU 72 managed by discrete control strategies 74, adaptable during damper operation. FIG. 27 illustrates a partial radial toroidal apparatus, showing two sets of aforementioned adjustable valves connected via a bi-directional fluid passageway, allowing fluid to discharge between the compression and extension fluid chambers.

FIG. 12 discloses an embodiment wherein a housing 10F accommodates a fluid barrier 34F and a piston 30F. Also disposed within the housing interior is a low pressure preload accumulator for pressurizing damper fluid in the housing interior for the purposes of temperature compensation, preferably a gas filled collapsible structure 76, the preload of which can be adjusted by changing the pressure.

FIG. 13 illustrates a housing 10G which includes enlarged flange segments 78 forming opposed connector portions having apertures 80 formed therein.

FIG. 14 shows the arrangement of FIG. 13 with the connector portions 78 secured by bolts 82 to brackets extending from fixed structural elements 84, 86. The shaft 40 and associated piston (not shown in FIG. 14) rotate relative to the fixed housing to perform the desired damping function.

FIG. 15 shows an embodiment wherein shaft 40 is attached to brackets of a structural element 88 and fixed against rotation relative thereto. In this arrangement, the housing 10I can rotate in a reciprocal manner about the shaft, the apparatus functioning as a rocker damper. Link members in the form of push-pull arms 90, 92 are connected to the housing 10I and reciprocally move fore and aft as the housing rocks back and forth. The toroidal rotary damper apparatus in this instance, due to its symmetrical geometry, effectively behaves as a rocker damper for opposing force vectors.

FIG. 16 illustrates a version of the toroidal rotary damper apparatus which is the same in all respects as the embodiment of FIGS. 1-5 except that the fluid barrier 34H is free of valves or passageways and flow control passageways 36H are defined by piston 30H. In this embodiment no valves are employed to control flow through the flow control passageways.

FIG. 17 illustrates a toroidal rotary damper apparatus 10 as constructed in accordance with the teachings of the present invention, which is employed remotely in association with a vehicle suspension system B, the toroidal rotary damper apparatus A is connected to a pivoting link of vehicle suspension B via arm C affixed to the central shaft 40 of the apparatus. Housing 10 is fixed solidly to the frame F of the vehicle.

FIG. 18 illustrates the housing 10 of toroidal rotary damper apparatus A′ constructed in accordance with the teachings of the present invention affixed to the frame F of a vehicle. In this instance, the apparatus A′ is disposed axially with the elongated element D of the suspension assembly which in turn is pivotally mounted on the vehicle frame F and fixedly connected to the ends of shaft 40 so that forces causing pivotal movement of the element D and the rest of the assembly will be dampened by apparatus A′.

FIG. 19 shows a toroidal damper apparatus A″ wherein the shaft 40 is affixed against movement to a vehicle frame F. The housing 10 of the apparatus A″ rotates relative to the shaft and the frame F. A link rod 94 interconnects the housing 10 to a pivoted element 96 of the suspension so that the apparatus A′ functions as a shock absorber. This is representative of the fact that the toroidal rotary damper apparatus can be utilized to accept tangential force vectors using mechanisms like push-rods or pull-rods effectively acting as a damped rocker system.

Referring now to FIG. 20, the housing 10J of a toroidal rotary damper apparatus is affixed against movement. The apparatus incorporates a moveable output member or lever 98 extending from a planetary gear assembly associated with the housing. The assembly includes a sun gear 100 affixed to shaft 40 of the apparatus. The sun gear 100 is surrounded by planetary gears 102 which mesh with the sun gear and with a ring gear 104 fixed in place externally of housing 10J. The planetary gears are rotatably mounted at the inner end of output member 98. This arrangement multiples the motion ratio between the shaft 40 and the moveable output member 98, a feature useful under certain circumstances, such as lever arm and linkage applications.

FIG. 21 shows a toroidal rotary damper apparatus 10K integrated into an external housing structure 110 where only the shaft (shaft 112) protrudes from both sides of the housing. In this embodiment the housing can be of solid material to increase structural rigidity and thermal dissipation; or the housing can be vacant. When vacant, the housing can function as an expansion vessel to store and provide fluid; furthermore, in case of inner shaft seal failure, space is provided to store fluid escaping through the corresponding seal, which in turn can reduce the internal pressure. This feature substantially increases reliability and aids in prevention of contamination.

FIGS. 22-27 show yet another preferred embodiment of the present invention, a partial toroidal rotary damper apparatus, generally denominated 500 herein. In this embodiment, the housing 510 is configured as only a partial toriod (in this instance, half a toroid), and includes an upper toroid housing member 520 and a lower toroid housing member 530, each provided with integral flanges 540, 550, having apertures 560 for insertion of fasteners 570 to couple the housing members. As in the first preferred embodiment, the upper and lower housing members define a housing interior 580 having an interior surface 590 in which a disc-shaped piston 600 is in constant slidable engagement. The piston includes a concentric ring or seal 610 to provide constant engagement with the interior surface of the housing.

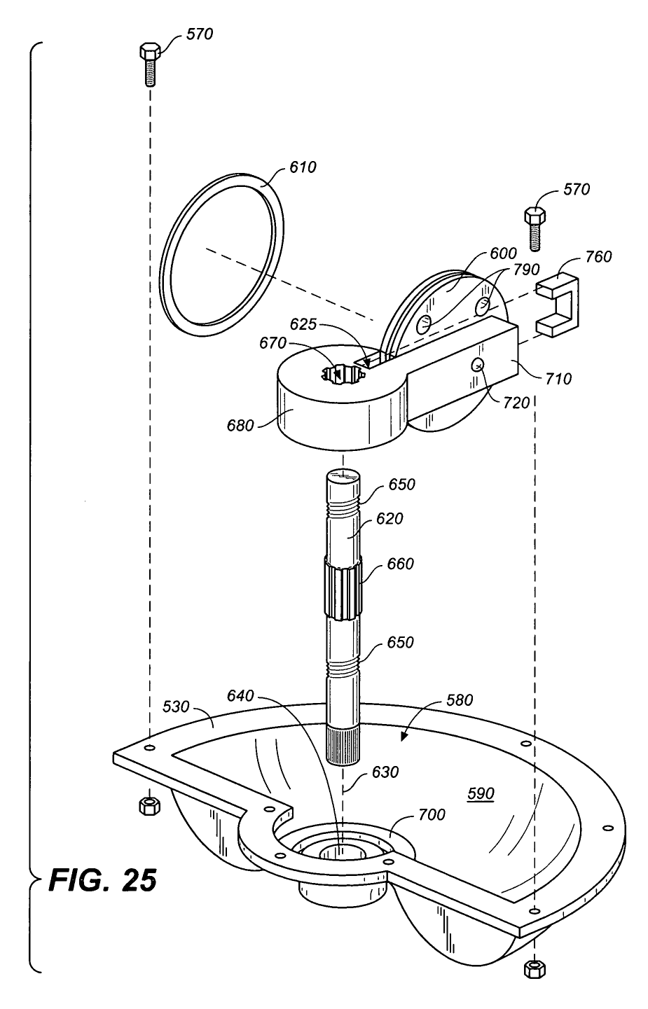

A shaft 620 is disposed along a central axis 630 and through central holes in the upper and lower housing members. Only the lower housing member hole 640 is illustrated herein. The shaft includes upper and lower threads 650 for engagement with nuts 655 to urge the housing members into mating relationship over the central portion, and it further includes splines 660 in its medial region for engagement with the splines 670 in a radial arm 680, which is seated between bosses 690, 700 and extends radially into the housing interior to support piston 600 on a bar 710. The piston is fixedly attached to the bar with a pin 720, which may be secured in any of a number of suitable ways, shown variously in FIGS. 25-27. Preferably, the pin includes countersunk elements 730 bracketing each side of bar 710, and a threaded portion 740 that inserts through the center of piston 600, secured by a nut 750, such that piston 600 can be easily removed for servicing. The countersink recesses 615 in the piston have slight clearances from the countersink elements of the pin to allow the pin some limited and predetermined amount of play during movement and changes in direction, which play is translated to piston 600.

Also, as in the first preferred embodiment, the partial toroid configuration employs a clip seal 760 positioned within a slot 625 in radial arm 680 and disposed between piston ring 610 and the radial arm, as well as radial face seals 770 and axial seals 780 to provide fluid tight seals between the housing interior and shaft 620.

Operational advantages may be obtained by providing flow control orifices 790 or passageways in piston 600, while the terminal sides 800, 810 of the toroidal housing function as fixed fluid barriers.

In an alternative embodiment, shown in FIG. 27, the damping characteristics of the inventive apparatus can be selectively and finely controlled for piston movement in each direction within the toroidal housing by providing adjustable valves 820 utilized to control flow through bi-directional fluid passageways 830. Possible valve adjustments means include a threaded manual adjustment screw 840 associated with one or more of the valves and may turned in or out relative to the housing to control valve opening. Alternatively, plungers 850 are operatively engaged with valves 820 and extend from electrical or hydraulic servo actuators 860. The servo actuators are controlled by control units or CPUs 870 managed by discrete control strategies 880. The entire control system is in fluid communication with the toroidal housing interior 580 through fluid passageways 890, and utilizing these operational and structural elements, fluid is allowed to enter and selectively discharge between compression and extension fluid chambers 900.

The foregoing disclosure is sufficient to enable one having skill in the art to practice the invention without undue experimentation, and provides the best mode of practicing the invention presently contemplated by the inventor. While there is provided herein a full and complete disclosure of the preferred embodiments of this invention, it is not intended to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, fimctions, operational features or the like.

Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A toroidal rotary damper apparatus, comprising, in combination:
a partial toroidal housing having terminal ends creating fluid barriers and defining a housing interior for containing damper fluid, said housing interior at least partially formed by a partial toroidal inner housing surface disposed about and spaced from an axis;
a piston in said housing interior having a curved outer peripheral piston surface in substantially fluid-tight engagement with said toroidal inner housing surface, spaced from said axis and disposed along a common plane with said axis, said housing and said piston being relatively rotatably movable about said axis; and
a flow control passageway provided either in said piston or in said fluid barriers for permitting controlled passage of damper fluid therethrough responsive to relative rotational movement between said piston and said partial toroidal housing to dampen forces applied to the toroidal damper apparatus causing said relative rotational movement.
